(19) United States
(12) Patent Application Publication
(10) Pub. No.: US 2018/0334134 A1
(43) Pub. Date: Nov. 22, 2018

(54) DEVICE FOR DETECTING BUCKLING AND DE-BUCKLING EVENTS

(71) Applicant: Erangi Desoyza, Southlake, TX (US)

(72) Inventor: Erangi Desoyza, Southlake, TX (US)

(21) Appl. No.: 15/899,347

(22) Filed: Feb. 19, 2018

Related U.S. Application Data
(60) Provisional application No. 62/461,174, filed on Feb. 20, 2017.

(51) Int. Cl. B60R 22/48; B60R 25/10

(52) U.S. Cl. CPC B60R 22/48; B60R 2022/4866; B60R 2022/4816; B60R 25/1004

(57) ABSTRACT

A system has a sensor and a wireless communication module. The sensor is configured to detect one more physical properties of a belt component being inserted in a seat belt housing. The wireless communication module is configured to transmit information concerning the one or more physical properties. In certain configurations, the system also has a distance module that detects the distance of the wireless communication module from the mobile device. The one or more physical properties indicate whether a buckled event has occurred. An alarm is sounded when a buckled event is detected in conjunction with a threshold distance of the wireless communication module from the mobile device being exceeded.

### TECHNICAL FIELD

This disclosure is generally directed to a seat belt-buckle monitoring systems. More specifically, this disclosure is directed to a device for detecting a buckling and de-buckling event.

### RELATED APPLICATIONS

This application is related to United States Provisional Application Nos. 62/461,174 (filed on Feb. 20, 2017), which are incorporated by reference herein for all purposes. The present application hereby claims priority under 35 U.S.C. § 119(e) to United States Provisional Application Nos. 62/461,174.

### BACKGROUND

Two very unfortunate events occur involving automobiles. First, seat belts are often not fastened or fastened and then removed. A seat belt cannot help to save lives unless it is properly used.

Second, hot car deaths are becoming more and more common. An adult charged with care of a child forgets the child is in the care, often resulting in debilitating effects from heat exposures, even death.

A conventional mechanism for monitoring a seat belt connection involves expensive rewiring of belt—if it can be done at all due to the type of seat belt.

### SUMMARY OF THE DISCLOSURE

According to an embodiment of the disclosure, a system has a sensor and a wireless communication module. The sensor is configured to detect one more physical properties of a belt component being inserted in a seat belt housing. The wireless communication module is configured to transmit information concerning the one or more physical properties. In certain configurations, the system also has a distance module that detects the distance of the wireless communication module from the mobile device. The one or more physical properties indicate whether a buckled event has occurred. An alarm is sounded when a buckled event is detected in conjunction with a threshold distance of the wireless communication module from the mobile device being exceeded.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The phrase “at least one of,” when used with a list of items, means that different combinations of one or more of the listed items may be used, and only one item in the list may be needed. For example, “at least one of: A, B, and C” includes any of the following combinations: A; B; C; A and B; A and C; B and C; and A and B and C. Definitions for certain words and phrases are provided throughout this patent document, those of ordinary skill in the art should understand that in many if not most instances, such definitions apply to prior, as well as future uses of such defined words and phrases.

### BRIEF DESCRIPTION OF THE DRAWINGS

For a more complete understanding of this disclosure and its features, reference is now made to the following description, taken in conjunction with the accompanying drawings, in which:

FIGS. 1A and 1B shows components for detecting latching of seat belt, according to particular embodiments of the disclosure;

FIG. 1C illustrates a signature used in detecting a latching or unlatching event;

FIGS. 2A and 2B shows components for detecting latching of seat belt, according to yet additional embodiments of the disclosure; and

FIG. 3 shows components for detecting latching of seat belt, according to yet another embodiment of the disclosure.

### DETAILED DESCRIPTION

The FIGURES described below, and the various embodiments used to describe the principles of the present disclosure in this patent document are by way of illustration only and should not be construed in any way to limit the scope of the disclosure. Those skilled in the art will understand that the principles of the present disclosure invention may be implemented in any type of suitably arranged device or system. Additionally, the drawings are not necessarily drawn to scale.

The Bucklebond device (referred to alternatively herein as a device or smart device) in certain embodiments addresses two major problems regarding child safety in automobiles today.

Children tend to avoid putting on their seat belts and they may even take them off while the car is moving. Many times the adult in charge is unaware of this. Many children have been killed or injured due to lack of proper seat belt use in accidents.

Hot car deaths are also becoming more and more common. Usually unknowingly, the adults in charge have left the children in cars because they simply forgot they were there. It takes very little time for child to die from heat exposure.

Certain embodiments of the disclosure help to drastically reduce the two aforementioned problems by alerting the adult in charge about:
1. the status of the buckle, namely whether it is fastened or not.
2. whether someone has left a child in the car. This is achieved by determining that the seatbelt is still buckled and the person with the connected smartphone application has left a predetermined narrow geosphere from the Bucklebond device.

Certain embodiments of the disclosure are unique in that they do not rely on replacing any seatbelt system, whether that be the actual vehicle seat belt for any infant/child car seat belt. According to one embodiment, this is achieved by using a relatively simple device that contains a magnetometer and a Bluetooth device that sticks to the back of the desired individual buckle. The device does not interfere with a safety mechanism in any way. This device can be retrofitted to any vehicle or child seat of any era.

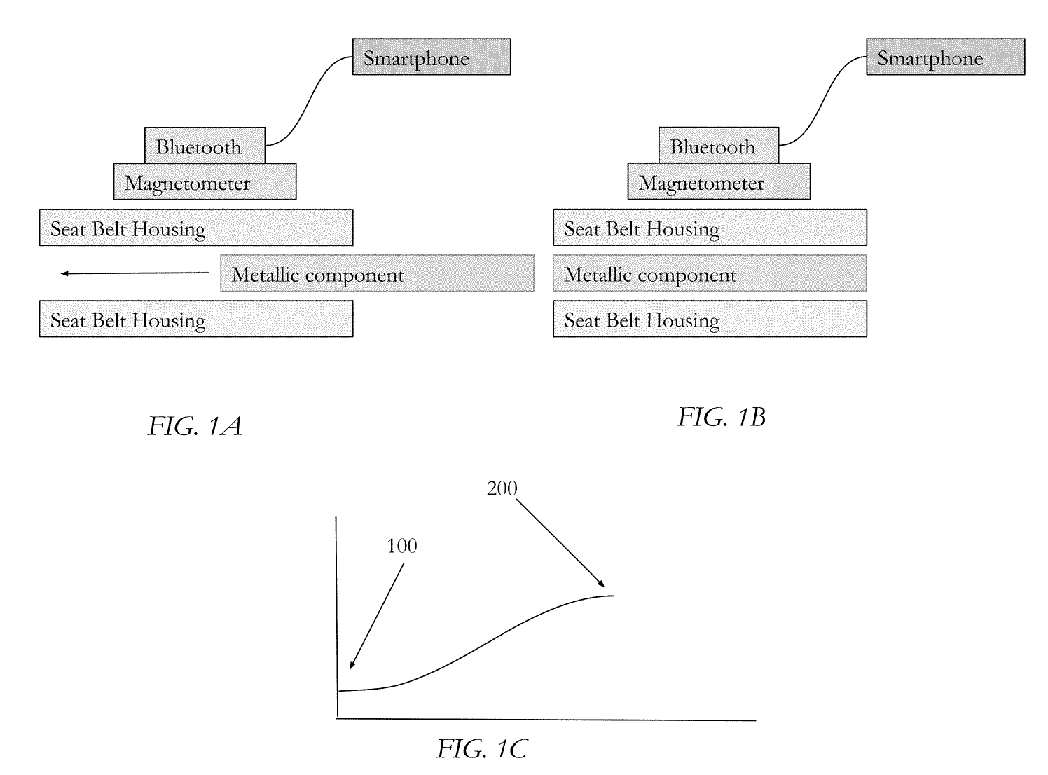

FIGS. 1A and 1B depicts a diagram of basic operation, according to an embodiment of the disclosure. It should be understood that the sizing of components have been exaggerated for illustration. Additionally, although other basic components may be utilized (e.g., processor, memory, etc), they have not been shown.

FIGS. 1A and 1B show a seat belt housing that has a metallic component inserted for latching (e.g., moving in the direction shown by the arrow). FIG. 1B shows the seat belt latched whereas FIG. 1A shows the seat belt unlatched. The Bucklebond device, which includes basic components such a magnetometer and a bluetooth module for wireless communication, is attached to the seat belt housing in any suitable manners (certain of such ones, which are described below).

In a set-up mode, a baseline is established as to magnetic readings with and without the metallic component being in place. As a non-liming example with reference to FIG. 1C, the device can be informed that it is in the set-up mode and monitor the changing magnetic field up to an ultimate latching. Arrow 100 may indicate a reading when no metallic component has been inserted at all. Arrow 200 may indicate a reading when a true latch has occurred. The device may also be informed latching has occurred to determine the final reading. As necessary, a smartphone with an application may communicate with the device, for example, using Bluetooth or any other wireless communication to inform the device of such items (e.g., click here on phone to indicate process started; click here to indicate latch is successful). As necessary, the process may be repeated to create a signature of what a successful latching event looks like. As seen, the insertion process creates a linear progression of insertion of the latch.

The device can use such a signature to determine whether a successful latching event has occurred. Contrary-wise, the device can also detect a de-latching event—also using the signature and a prior state of being latched. Although not necessarily used by every configuration, the measurements between arrow 100 and arrow 200 may form part of the signature. This data may be wireless and continuously transmitted via close proximity Bluetooth to the smart device or cell phone, alerting an application or program when needed.

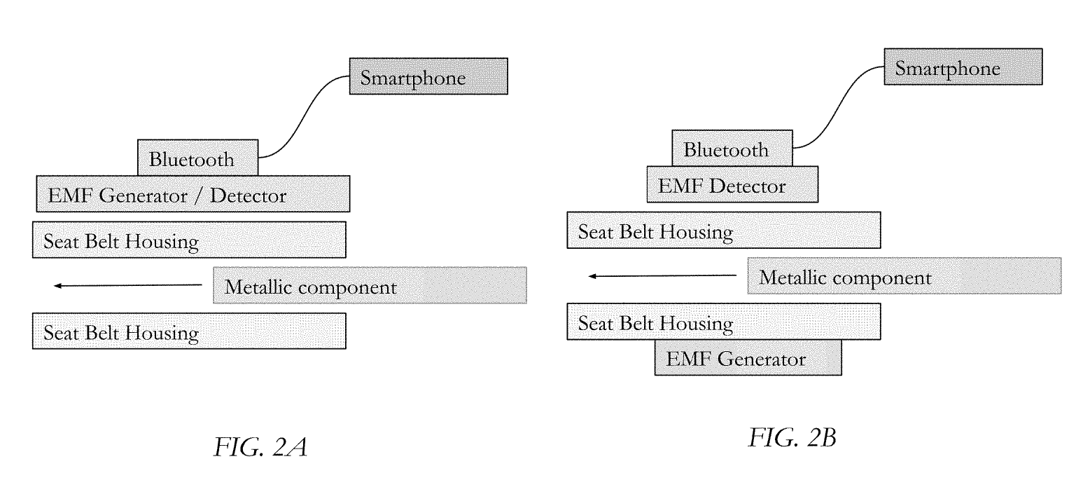

Although a magnetometer is shown in this embodiment, any other type of sensor may be utilized according to other embodiments of the disclosures. Such sensors measure a change in some physically measurable component as a result of the insertion of the belt component, which is often metallic. As a first non-limiting example with reference to FIGS. 2A and 2B, an electromagnetic field sensor may be utilized in other embodiments of the disclosure as insertion of a magnetic component will modify the electromagnetic field. In certain embodiments, the magnetic field may be artificially generated and measured with insertion of the seat belt component. As a simple example, a directional antenna may propagate a limited electromagnetic wave and measure a signature response, which change based on the insertion of the seat-belt component, which may be magnetic. With reference to FIG. 2A, both the generator and detector may be placed on the same side as the bluetooth device. Alternatively, with reference to FIG. 2B one component may be inserted on one side of the housing and the sensor placed on the other to detect changes based on insertion. As another non-limiting example, an audio sensor may measure a signature sound that occurs when successful latching occurs. Each of such sensors may undergo a set-up procedure to determine the appropriate signature for a successful latch. Yet other sensors, including other types of magnetic sensors may be utilized.

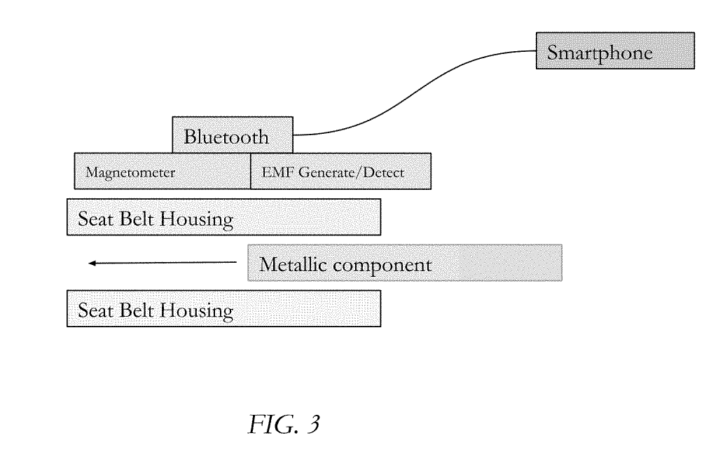

Additionally, with reference to FIG. 3, in certain embodiments, a combination of sensors (and corresponding signatures) may be utilized to determine a successful latching. In such configurations, the multiple sensors may enhance the determination of whether a buckling or de-buckling event has occurred.

In particular embodiments, the state of the buckle is compared against a geo-distance between the device and a smartphone. A variety of techniques can be used to detect distance, including, but not limited to loss of signal strength or loss of signal that may be omitted from the device. Thus, if a person with the smart phone application leaves a predetermined geosphere of the vehicle, the device detects if the latch plate is still attached to the buckle to not. If the buckle has been detached the smart device is notified and assumes the child has left the vehicle. If the buckle is still attached the start phone application knows this and therefore alerts the individual (e.g., via the smartphone) that the child may still be in the car. Such a feature will help prevent hot car deaths.

In particular embodiments, the device may be powered by small, easily replaceable batteries and the battery power level will be forwarded to the smart device application so that the battery can be replaced as needed. In particular configurations, a battery level may be communicated via bluetooth to inform a user that a battery needs to be placed.

In particular configurations, a safety mechanism may also be incorporated to alert a user if the device falls off the seat buckle housing. As an non-limiting example, the device may compare the various states it believes it should be detecting—including buckled and not bucked. If the device suddenly falls off, the signature of what a buckling or de-buckling looks like will be greatly changed—suggesting it has fallen off. As a further example of this with reference to FIG. 1C, the change in magnetic field through a natural de-buckling event looks different signature-wise than when the seat belt falls off. The use of multiple sensor in particular configurations may enhance such a determination. The detection of a device disconnection can trigger an alert for the owner to check the device.

The device can also be used for adult passengers such as the very elderly or people with dementia and memory loss, or impaired adults (inebriated, etc). Any of a variety of alerts can be sent to a smart phone app. With this device the driver or the owner of the smart device application will know who has their seatbelt buckled. This is important for everyone, as unbuckled rear passengers become heavy projectiles in motor vehicle accidents.

In particular embodiments, the device does not require expensive retrofitting or tampering with existing seat belts. Most vehicles in the world today do not have seat belt detectors in the rear seats. Most commercial child safety car seats do not have seatbelt detectors either. Certain retrofit seat belt detectors are available but they are wired and require new buckles and latch plates or modification of existing ones, and are therefore expensive. Particular embodiments of this device can be easily installed by sticking the device to the back of any seat belt buckle. This would be a simple task that can be accomplished by anyone with even limited technical abilities.

In particular configurations, the device's electronics to be enclosed in a somewhat malleable, soft rubber or plastic. It would have an adhesive on the back so that it could stick to many different shapes of buckles. The adhesive in certain configurations is strong enough that it requires an adhesive remover such as Goo Gone to remove it. The device in certain configurations could also be removed in a similar fashion to a Command Strip. In certain configurations, the device can be small and thin. Each device can also have its own signature identifier that would connect with the Bucklebond smart device application.

In particular configurations, the smart device application information can also be forwarded to another smart phone device via cellular network as well. In this way a parent can tell if their teenager and his or her passengers are wearing their seatbelt, when they have gone for a movie for example.

Although certain configurations have been described as communicating with a phone, certain other configurations of the device may pair up with a vehicles' receiver and interact with an application on the vehicles computer screen. In this way the application could detect when the engine has been turned off. If the driver's door is opened and one of the buckles is still attached, an alert is sent to the smart device application. This will alert the driver to make sure no one is it inadvertently left in the car.

Key Fob Device

For those who are prone to leaving their smart device in the car or at home, or the last store they went to, a key fob device is also disclosed. The smart device (e.g., a smart phone) is a key component for the Bucklebond device to be effective. Therefore, it is important that people do not leave their phone at home or any other place, when they leave the house in their automobile. Thus, the key-fob device can help locate the smart device.

In particular configurations, a keychain fob with a small Bluetooth receiver and an electronic alarm is provided. This will help prevent people from leaving their phone in their car or at home or anywhere else. When the person walks away from their smart device with their keys in hand (and the fob on the keychain) the key-fob will alarm and remind them that they have left their phone.

This key fob device will also help prevent people from losing their keys. Say for example, you go to a restaurant to eat lunch and you leave your keys on the table. You get done with your lunch and get up and leave the restaurant with the phone in your pocket. As you walk a certain distance away from your keys your phone and your keys will start to alarm. This would obviously alert you that you've left one or the other at the table. Vice versa, if you had left the restaurant without your phone, your key would start alarming when it has left your phones geosphere. This would alert you to go back to get your phone.

Accelerometer

Particular embodiments of the Bucklebond device also incorporate an accelerometer. This would set off several alerts if an extreme deceleration has occurred suggesting a motor vehicle accident. A message about the sudden deceleration can be sent to a parent or other preset family or friends with the smart device application, suggesting that an accident may have taken place. The cell phone or smart device in the accident could also be made to dial 911 due to the application detecting the deceleration information from the Bucklebond device. An illustrative scenario would be as follows: a parent gives his car keys to his son to go to a movie with his friends. His son has the buckle bond application on his phone as does the father. The Bucklbond device ensures that everyone in the car as their seat belts on. The father is aware of this because his son's cellphone application is sending him information over the cellular network about the status of the seat belts and the GPS location of his son's cell phone. Unfortunately, his son gets into a car accident and the sudden deceleration is picked up by the accelerometer in the Bucklebond device which then sends a notification to the father that an accident may have occurred and simultaneously to the son's cell phone which automatically dial 911. 911 can locate the accident using the GPS data from the son's cell phone in the accident. The father has also been getting GPS location data from his son's cell phone.

In Summary, according the various embodiments, the following is provided:
1. The Bucklebond device notifies you if the child has not put on seat belt or takes it off when they are not supposed to.
2. Can alert that child may still be left in car—Possible reduction of hot car deaths.
3. Key fob device that communicates with smart phone/device that helps prevent owner from losing either. The owner needs to have the smart device/phone for the Bucklebond device to do its job.
4. Accelerometer in Bucklebond can help it detect possible accident and then send a signal to the cell phone, which automatically dials emergency services and notify family/friend.

It will be understood that well known processes have not been described in detail and have been omitted for brevity. Although specific steps, structures and materials may have been described, the present disclosure may not limited to these specifics, and others may substituted as is well understood by those skilled in the art, and various steps may not necessarily be performed in the sequences shown.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A system comprising:
a sensor configured to detect one more physical properties of a belt component being inserted in a seat belt housing; and
a wireless communication module configured to transmit information concerning the one or more physical properties.

2. The system of claim 1, wherein the wireless communication module uses Bluetooth.

3. The system of claim 1, wherein the wireless communication module sends the information to an application on a mobile device.

4. The system of claim 1, further comprising:
a distance module which detects the distance of the wireless communication module from the mobile device.

5. The system of claim 4, wherein
the one or more physical properties indicate whether a buckled event has occurred, and
an alarm is sounded when a buckled event is detected in conjunction with a threshold distance of the wireless communication module from the mobile device being exceeded.

6. The apparatus of claim 1, wherein wireless communication module and sensors are a retrofit to an existing belt component and seat belt housing.

7. The apparatus of claim 1, wherein the sensor is a magnetometer.

8. The apparatus of claim 1, wherein the sensor is an electromagnetic field sensor.

9. The apparatus of claim 1, wherein a buckling event is determined by comparing the detected one or more physical properties to a signature.

10. The apparatus of claim 9, wherein the signature is generated in a training sequence involving gathering information in response to the buckling event.

11. The apparatus of claim 1, further comprising:
a signal generator configured to generate signals that are received by the sensor; the signals modified by belt component when present.
